(19) United States
(12) Patent Application Publication
(10) Pub. No.: US 2014/0327909 A1
(43) Pub. Date: Nov. 6, 2014

(54) METHOD FOR EXCITING A SUB-WAVELENGTH INCLUSION STRUCTURE

(71) Applicants: Mikael KÄLL, (US); Mikael SVEDENDAHL, (US)

(72) Inventors: Mikael Käll, Onsala (SE); Mikael Svedendahl, Göteborg (SE)

(21) Appl. No.: 14/365,723

(22) PCT Filed: Dec. 14, 2012
(86) PCT No.: PCT/SE2012/051399

§ 371 Date: Jun. 16, 2014

Related U.S. Application Data
(60) Provisional application No. 61/576,361, filed on Dec. 16, 2011.

(51) Int. Cl. G01N 21/63; G02B 5/00; G01N 21/21; G01N 21/45; G01N 21/41; G01N 21/65

(52) U.S. Cl. CPC G01N 21/63; G01N 21/4133; G01N 21/658; G01N 21/211; G01N 21/45; G02B 5/008
USPC 356/327; 356/128; 356/326; 356/369; 356/450; 359/241

(57) ABSTRACT

The invention concerns a method for exciting a sub-wavelength inclusion structure, comprising: providing a first medium having a first refractive index nᵢ and a second medium having a second refractive index nₜ, wherein nᵢ>nₜ, wherein the sub-wavelength inclusion structure is arranged at a boundary between the first and second media, wherein the sub-wavelength inclusion structure exhibits polarizability properties; and directing light through the first medium towards the sub-wavelength inclusion structure. The angle of the incident light to the normal of the boundary, θᵢ, is such that, for a given set of: frequency of the light; surface density of inclusions; average polarizability of the inclusion structure at the frequency; first refractive index; and second refractive index, θᵢ fulfils at least one of the relations for s-polarized light and for p-polarized light described herein.

### TECHNICAL FIELD

This invention relates to a method for exciting a sub-wavelength inclusion structure arranged at a boundary between a first and a second medium by directing light through the first medium towards the sub-wavelength inclusion structure. The invention also relates to a method for carrying out refractometric sensing, surface enhanced spectroscopy and/or optical trapping using the method for exciting the sub-wavelength inclusion structure.

### BACKGROUND OF THE INVENTION

Nanotechnology and the use of nanostructured surfaces have greatly contributed to the development of new improved sensors. The nano-physical properties of the nanostructures, can greatly contribute to e.g. enhancing otherwise weak sensing signals or indirect sensing of changes in the sensing material or environment, as described in e.g. WO 2012/136440.

One example is Surface Enhanced Raman Spectroscopy (SERS), described in e.g. US2012050732. SERS is an elaboration of Raman spectroscopy—a well-known optical sensing technique that uses the inelastic scattering of photons from molecules in order to provide detailed information on the chemical structure of the molecule. A problem with traditional Raman spectroscopy is that the signals are very weak. But with the aid of nanostructures on a surface, such as gold- or silver-based nanosubstrates, a Raman signal can be enhanced 10⁴ to 10⁸ times or even higher. This enhancement is due to spatially localized surface plasmon resonance (LSPR) in the nanostructure, generated by the incident light.

Although being an enhancement, Surface Enhanced Raman Spectroscopy (SERS)—as well as several other surface enhanced spectroscopies—still are relatively inefficient and need very good notch filters not to have the signal overwhelmed by the excitation light.

### SUMMARY OF THE INVENTION

An object of this invention is to provide a way to increase the sensitivity in, for example, SERS measurements. This object is achieved by the method defined by the technical features contained in claim 1. The dependent claims contain advantageous embodiments, further developments and variants of the invention. As will be described below the invention can be used in other applications than SERS measurements.

The invention concerns a method for exciting a sub-wavelength inclusion structure, comprising the step of: providing a first medium having a first refractive index nᵢ and a second medium having a second refractive index nₜ, wherein nᵢ>nₜ, wherein the sub-wavelength inclusion structure is arranged at a boundary between the first and second media, wherein the sub-wavelength inclusion structure exhibits polarizability properties; and directing light through the first medium towards the sub-wavelength inclusion structure.

The invention is characterized in that the angle of the incident light to the normal of the boundary, θᵢ, is such that it, for a given set of: frequency of the light ω; surface density of inclusions ρ; average polarizability α of the inclusion structure at the frequency ω; first refractive index nᵢ; and second refractive index nₜ, fulfils at least one of the following relations: for s-polarized light:

$$\frac{ω}{c} ρ α ( ω ) = \text{?} \vert \text{?} \vert + \text{?} cos \text{?} , \\ \text{?} \text{indicates text missing or illegible when filed}$$

and/or for p-polarized light:

$$\frac{ω}{c} ρ α ( ω ) == - \frac{\text{?}}{\vert \text{?} \vert} + \text{?} \frac{{n}_{i}}{\text{?}} , \\ \text{?} \text{indicates text missing or illegible when filed}$$

where c is the speed of light in vacuum, where i is the imaginary unit, and where θₜ is the light propagation angle in the second medium determined by the law of refraction:

nₜ sin θₜ=nᵢ sin θᵢ.

By directing light as specified in the inventive method it is possible to totally absorb the light, or at least a particular wavelength fraction of the light, in the sub-wavelength inclusion structure by maximizing coupling efficiency of the incident light to the near fields of the structure. The sub-wavelength inclusion structure is thus loaded with more energy than if total absorption is not achieved. Typically, the structure is a nano-structure with inclusions in the size range less than 100-1000 nm. The wavelength typically utilized is in the range 300-1500 nm. In such a structure the inclusions form nano-antennas. Other sizes and wavelength are, however, possible.

The inventive method leads to stronger output signals useful for surface enhanced spectroscopy or refractometric sensing where it is important to detect changes of the nanoantennas and/or the surrounding environment upon changes in chemical composition/temperature/pressure of the surrounding medium.

Total absorption has a further advantage in that it removes the disturbing background light that conventionally makes it necessary to use advanced filters to detect the measurement signal properly in incoherent or inelastic spectroscopy techniques.

The term “inclusions” refers to any type of particles (or similar) capable of providing surface charges and surface currents to the remaining plane boundary between two dielectrics. The theory behind this is usually referred to as the “island film theory”.

Non-polarized light is a mix of s- and p-polarized light. Also non-polarized light can be totally absorbed by the inventive method. In such a case the inclusions must exhibit different polarizability in the x- and y-directions, which can be achieved by designing the inclusions such as to extend over a longer distance in one direction (x) than in the other direction (y).

The invention is based on the following findings:

The reflection from a dielectric boundary with additional small inclusions is conveniently described by modified Fresnel reflection coefficients. The reflection coefficients, considering only electric dipolar responses of the inclusions, are given by:

$${r}_{s} = \frac{{n}_{i} cos {θ}_{i} - {n}_{t} cos {θ}_{t} + i k y}{{n}_{i} cos {θ}_{i} + {n}_{t} cos {θ}_{t} - i k y} \\ {r}_{p} = \frac{{K}_{-} - i {k ( γcos {θ}_{i} cos {θ}_{t} - {n}_{i} {n}_{t} {ɛ}_{i} β {sin}^{2} {θ}_{i} )}^{′}}{{K}_{+} - i k ( γcos {θ}_{i} cos {θ}_{t} + {n}_{i} {n}_{t} {ɛ}_{i} β {sin}^{2} {θ}_{i} )} \qquad ( 1 )$$

where

K_{±}=(nₜ cos θᵢ±nᵢ cos θₜ)(1−1/4k²εᵢγβ sin² θᵢ (2)

γ=γ′iγ″. and β=β′+iβ″ are the in-plane and out-of-plane dipolar polarizability of a single inclusion of the boundary, respectively. k is the wave number in vacuum and nₘ and θₘ denote the refractive index and light propagation angle in the medium m, with i as the incident and t as the transmission medium.

Metallic nanoparticles may be utilized to achieve zero reflection when illuminated above the critical angle. Such nanoparticles may have distinct in-plane and out-of-plane polarizabilities, which, using Equation (1), have different excitation conditions for maximized excitation.

The general condition for total absorption of s-polarized light, incident above the critical angle, is for s-polarization given by:

$$\{ \begin{matrix}{n}_{i} cos {θ}_{i} = {ky}^{″} \\ {n}_{t} \vert cos {θ}_{t} \vert = {ky}^{′}\end{matrix} . \qquad ( 3 )$$

The same condition can be written for p-polarized incident light, assuming that the inclusions have much stronger in-plane polarizability than out-of-plane polarizability at the excitation wavelength. The condition for total absorbance with p-polarized light incident above the critical angle is:

$$\{ \begin{matrix}{n}_{i} / cos {θ}_{i} = {ky}^{″} \\ {n}_{t} / \vert cos {θ}_{t} \vert = - {ky}^{′}\end{matrix} . \qquad ( 4 )$$

Similarly, the condition for total absorption for p-polarized light for inclusions with much stronger out-of-plane polarizability, β>>γ, is:

$$\{ \begin{matrix}\frac{cos {θ}_{i}}{{n}_{i} {ɛ}_{i} {sin}^{2} {θ}_{i}} = k {β}^{″} \\ \frac{\vert cos {θ}_{t} \vert}{{n}_{t} {ɛ}_{i} {sin}^{2} {θ}_{i}} = k {β}^{′}\end{matrix} , \qquad ( 5 )$$

where εᵢ is the dielectric constant of the medium of incidence.

Total absorption and zero reflection for incidence angles above the critical angle has been reported, but was misinterpreted as the proof of a wave-guiding mode. The above formalism reveals that no such modes are necessary to achieve zero reflection. In fact, the optical properties of an interface with a given surface density of nanoinclusions should be maintained even if a single “unit cell” is illuminated. In this context the unit cell comprises a single nanoinclusion and a corresponding bare interface area, to keep the surface density constant. Thus, total absorption can ultimately be realized at the single nanoinclusion level, where no waveguideing mode can be maintained. The highly dispersive spectral features and the possibility of total absorption for p-polarized light serve as proof of the interference description given above, see FIG. 1, and where not previously reported.

In an embodiment of the invention the method further comprises the step of measuring or detecting a response from the sub-wavelength inclusion structure upon an at least local change in chemical composition, temperature and/or pressure of the second medium or upon a change of the sub-wavelength inclusion structure itself. This includes responses from substances interacting with the sub-wavelength inclusion structure such as inelastic emission involved in SERS and fluorescence measurements.

In an embodiment of the invention the step of measuring or detecting the response from the sub-wavelength inclusion structure comprises measuring or detecting light emitted from the sub-wavelength inclusion structure or from substances interacting with the sub-wavelength inclusion structure.

In an embodiment of the invention the sub-wavelength inclusion structure comprises a plurality of individual sub-wavelength inclusions, each of which being capable of supporting a localized surface plasmon resonance. An example of this is gold nanodiscs.

In an embodiment of the invention the first medium forms a solid support for the sub-wavelength inclusion structure.

In an embodiment of the invention the individual sub-wavelength inclusions have a length or diameter of less than 1000 nm.

In an embodiment of the invention the first medium is a glass material.

In an embodiment of the invention the second medium is air, water or an aqueous solution.

The invention also concerns a method for carrying out refractometric sensing, surface enhanced spectroscopy and/or optical trapping, which method comprises a method for exciting a sub-wavelength inclusion structure as described above.

### BRIEF DESCRIPTION OF DRAWINGS

In the description of the invention given below reference is made to the following figures:

FIG. 1

Experimental verification of dispersive spectral features and zero reflectance. The reflection spectra is dependent on the incident angle (a-d). S-polarized reflections below the critical angle show highly dispersive spectral line shapes around 38-41 degrees incidence (b-c). Above the critical angle the transmittance is zero and, as the reflection is zero around λₘᵢₙ=1.9 eV (650 nm) using p-polarized light, all light is absorbed by the nanoparticles at λₘᵢₙ (e).

FIGS. 2+3

Method illustration of total absorption enhanced surface enhanced spectroscopies. By tuning the specified incident angle, θᵢ, and wavelength into the total absorption condition, the near fields close to the metal nanoparticles are enhanced at the same time as the direct reflection at the excitation wavelength is significantly decreased. The excitation geometry thus increases the efficiency of the surface enhanced process (fluorescence, surface enhanced Raman spectroscopy, etc.) while also decreasing the need for filtering out the excitation light.

FIGS. 4+5

Method illustration of bulk refractive index sensing using spectroscopic measurements. The change in position of the reflectance minimum (Δλₘᵢₙ) is utilized to determine the refractive index change of the sensing/second medium.

FIGS. 6+7

Method illustration of bulk refractive index sensing using intensity measurements. The refractive index change of the sensing/second medium may be measured at a single wavelength, utilizing the zero background due to total absorbance of the incident light.

FIGS. 8+9

Method illustration of local refractive index sensing. As the spectroscopic properties of metallic nanoparticles are sensitive to the local refractive index, spectroscopic measurements can be utilized to probe the adsorption of small molecules on or near the metal surface.

FIGS. 10+11

Method illustration of local refractive index sensing. As the spectroscopic properties of metallic nanoparticles are sensitive to the local refractive index, intensity measurements can be utilized to probe the adsorption of small molecules on or near the metal surface.

FIGS. 12+13

Method illustration of an angular detection scheme. As the metallic nanoparticles alter their spectroscopic response due to changes in their environment, the angle for total absorbance is shifted. The angle of minimum reflectance can be used to track the changes in the sensing medium.

FIGS. 14+15

Method illustration of phase measurements of the reflected light. The reflected light in the vicinity of the perfect absorbance condition can be utilized as a signal transducer for refractometric sensing (either bulk or local). This can be done by using either dual path or common path (see FIGS. 16 and 17) methodologies. In the dual path interferometric approach, the incident light is split into two, a reference beam and a signal beam. The reference beam interferes with the reflection from the sample creating either constructive or destructive interference. This can be measured as a function of intensity (as illustrated by I1 and I2), or by detecting the movement of interference fringes.

FIGS. 16+17

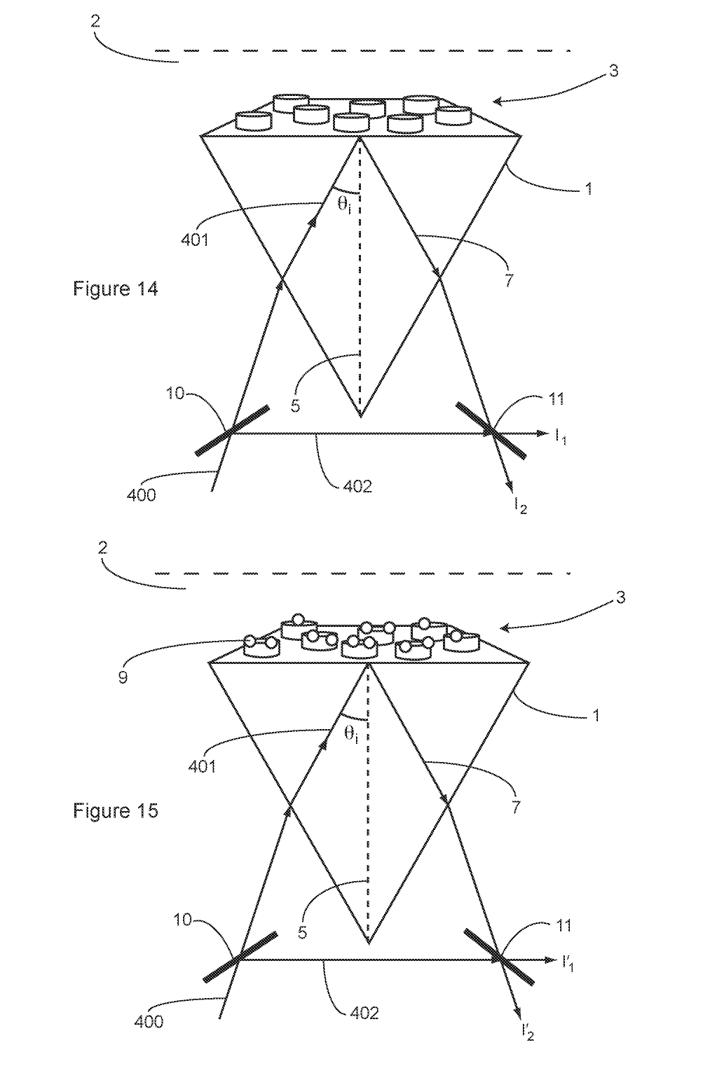

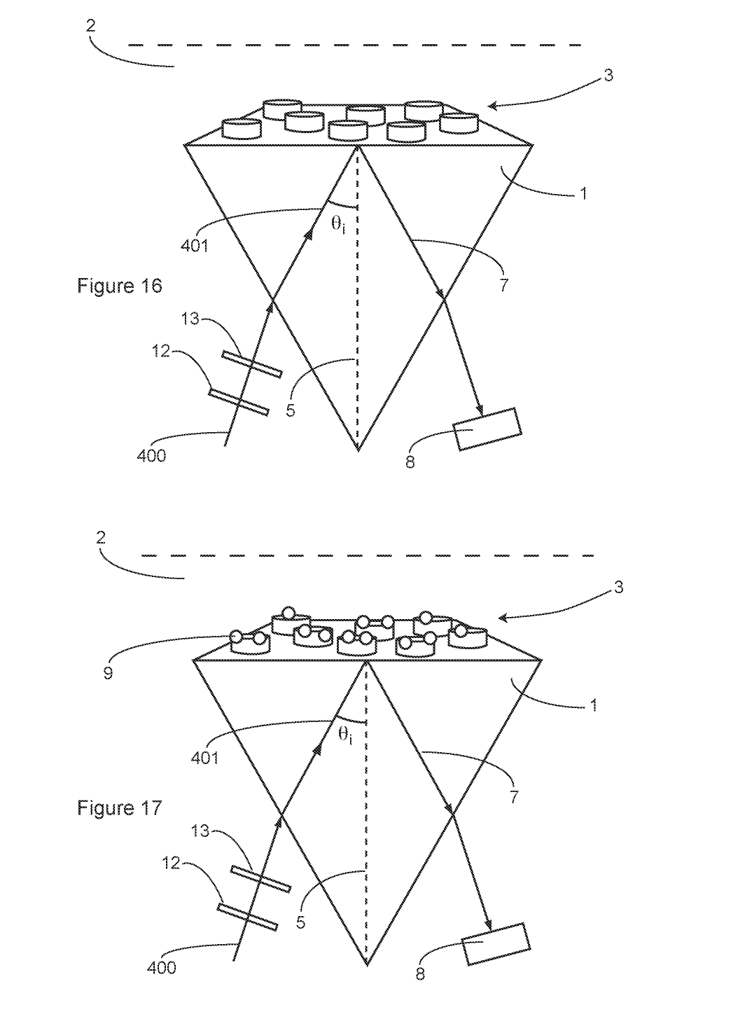

Method illustration of phase measurements of the reflected light. The reflected light in the vicinity of the perfect absorbance condition can be utilized as a signal transducer for refractometric sensing (either bulk or local). This can be done by using either dual path (see FIGS. 14 and 15) or common path methodologies. The common path method utilizes the interference between p- and s-polarization. The phase difference between the components can be deduced by rotating a polarizer and/or a retardation plate, altering the phase and/or intensity ratio of the incident p- and s-polarized components, and studying the reflection intensity or spectrum.

### DESCRIPTION OF EXAMPLE EMBODIMENTS OF THE INVENTION

When a dielectric boundary with a plurality of small (in relation to the wavelength of the light) inclusions is illuminated above the critical angle, the collective coherent scattering of the inclusions interfere with the reflection from the boundary between the two media. At certain conditions, the components interfere completely destructively, and no light at all is reflected. And since the illumination takes place above the critical angle, no light is transmitted either. Instead, the incoming light is totally absorbed by the structure of small inclusions in the dielectric boundary.

In order to achieve total absorption in, the angle of the incident light to the boundary, θᵢ, (i.e. in relation to the normal of the boundary) must fulfil the following relations:

For s-polarized light:

$$\frac{ω}{c} ρ α ( ω ) = \text{?} \vert \text{?} \vert + \text{?} cos \text{?}$$

$$\text{?} \text{indicates text missing or illegible when filed}$$

For p-polarized light:

$$\frac{ω}{c} ρ α ( ω ) = - \frac{\text{?}}{\vert \text{?} \vert} + \text{?} \frac{\text{?}}{\text{?}} , \\ \text{?} \text{indicates text missing or illegible when filed}$$

where ω is the angular frequency of the light, c is the speed of light in vacuum, nᵢ is the index of refraction in the medium from which the boundary is illuminated (the first, incident medium), nₜ is the refractive index of the other medium (the second, transmission medium), ρ is the surface density of the inclusions, α is the polarizability of the inclusion structure (the average polarizability in the illuminated area) at the frequency ω and i is the imaginary unit. The second angle θₜ, i.e. the light propagation angle in the transmission (second) medium, is determined by the law of refraction:

nₜ sin θₜ=nᵢ sin θᵢ.

The wavelength of the light is given from the ratio 2πc/ω.

How to determine the polarizability is known to the person skilled in the art, see for instance Optical response of supported gold nanodisks, A. Mendoza-Galván et al., Optics Express, Vol. 19, Issue 13, Page 12093, June 2011.

In the following examples the sub-wavelength inclusion structure 3 comprises a plurality of individual sub-wavelength inclusions 3a, each of which being capable of supporting a localized surface plasmon resonance.

In a first example, if the dielectric boundary is between glass (nᵢ=1.5) and air (nₜ=1) and if the sub-wavelength inclusion structure is constituted by gold nanodiscs (individual sub-wavelength inclusions) of an approximate height of 20 nm and a diameter of 120 nm, leading to a polarizability of α=−7.98·10⁻²¹+i1.15·10⁻²⁰ m³ for p-polarized light, with a surface density of ρ.=20.1 nanodiscs per μm², and the frequency of the incident light is ω=2.90·10¹⁵ rad/s, then the angle for which total absorption occurs for p-polarized light is θᵢ=52°.

In a second example, still with a boundary between glass and air, but were the inclusions are constituted by gold nanodiscs of an approximate height of 27 nm and a diameter of 110 nm leading to a polarizability of α=−2.89·10⁻²¹+i1.11·10⁻²⁰ m³ for s-polarized light, a surface density of ρ.=9.9 nanodiscs per μm², and the frequency of the incident light is ω=2.95·10¹⁵ rad/s, then the angle for which total absorption occurs for s-polarized light is θᵢ=43°.

In a third example, the dielectric boundary is between sapphire (n₁=1.77) and water (nₜ=1.33) and the inclusions are constituted by silver nanoparticles with a height of 22 nm and a diameter of 120 nm, resulting in a polarizability of α=1.91·10⁻²¹+i3.42·10⁻²⁰ m³ for s-polarized light, a surface density of 4.4 nanoparticles per μm², and the frequency of the incident light is ω=2.28·10¹⁵ rad/s, then the angle for which total absorption occurs for s-polarized light is θᵢ=49°.

In a fourth example, the dielectric boundary is between glass (n₁=1.5) and an aqueous buffer solution (nₜ=1.33) (which is useful for keeping bio-molecules in a stable state) and the inclusions are constituted by aluminium particles with a height of 12.4 nm and a diameter of 112.6 nm, resulting in a polarizability of α=−7.74·10⁻²¹+i1.10·10⁻²⁰ m³ for p-polarized light, a surface density of 44.6 particles per μm², and the frequency of the incident light is ω=2.98·10¹⁵ rad/s, then the angle for which total absorption occurs for p-polarized light is θᵢ=72°.

Besides borosilicate glass and sapphire the first medium can be for example silicon, silica/quartz, indium tin oxide (ITO) and lithium niobate. In principal, all materials can be used that are transparent to the light wavelength in question. Besides air, water and aqueous solutions, the second medium can be another gas than air or for example an organic solution. The relation between nᵢ and nₜ must of course also be considered.

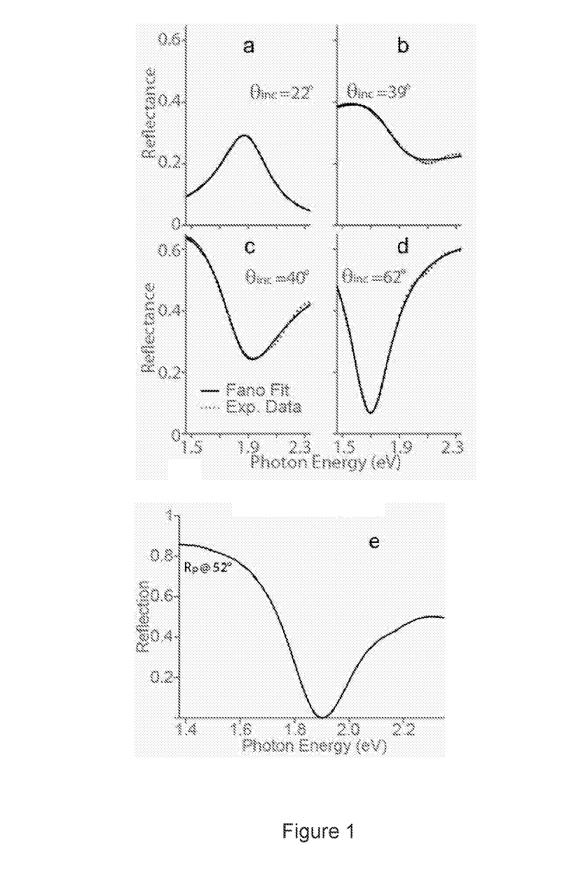

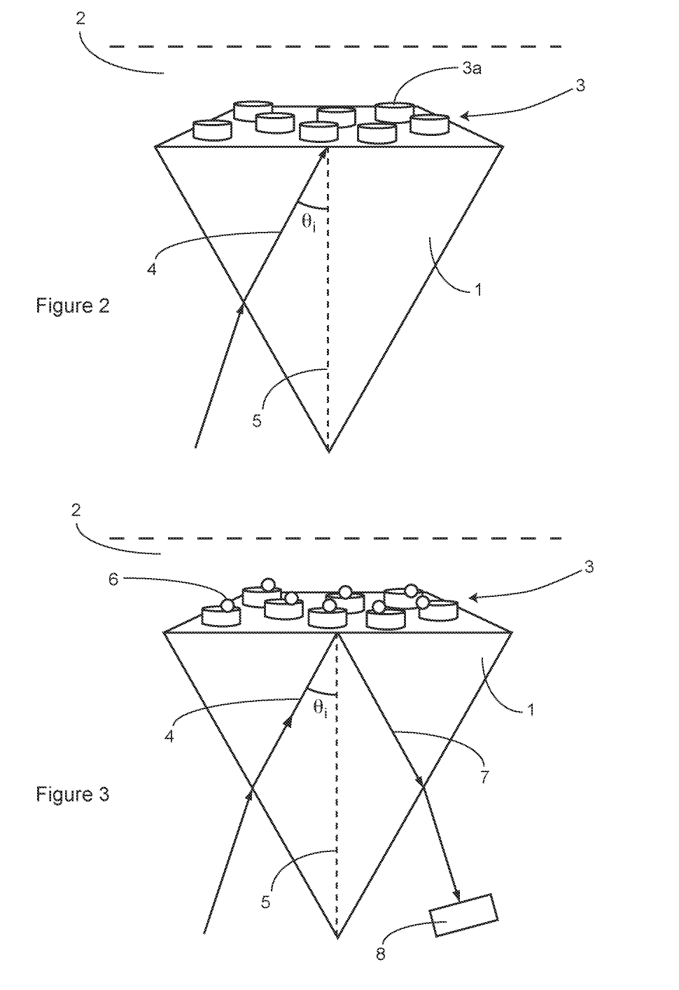

FIGS. 1e and 2 show examples of what is described above.

The following is directed towards inventive practical applications of the findings described above. The invention involves ultra-sensitive, all-optical, real-time sensing platforms based on arrays of nanoscopic objects and a dielectric interface on which the nanoscopic objects are immobilized.

In FIG. 2, incident light (4) is directed through a first medium (1) towards a sub-wavelength inclusions structure (3), constituted by a plurality of individual sub-wavelength inclusions (3a), at the boundary between the first medium and a second medium (2). The angle θᵢ of the incident light (4) to the normal (5) of the boundary is chosen to fulfil the conditions for total absorption. Hence, no light is reflected or transmitted.

In FIG. 3, the arrangement in FIG. 2 is used to enhance surface enhanced spectroscopy. Here, spectroscopically active molecules (6)—such as fluorophores, fluorescence resonance energy transfer (FRET) pairs or surface enhanced Raman spectroscopy (SERS) active molecules—are attached to the inclusions structure (3). The excitation geometry increases the efficiency of the surface enhanced process, while also decreasing the need for filtering out the excitation light.

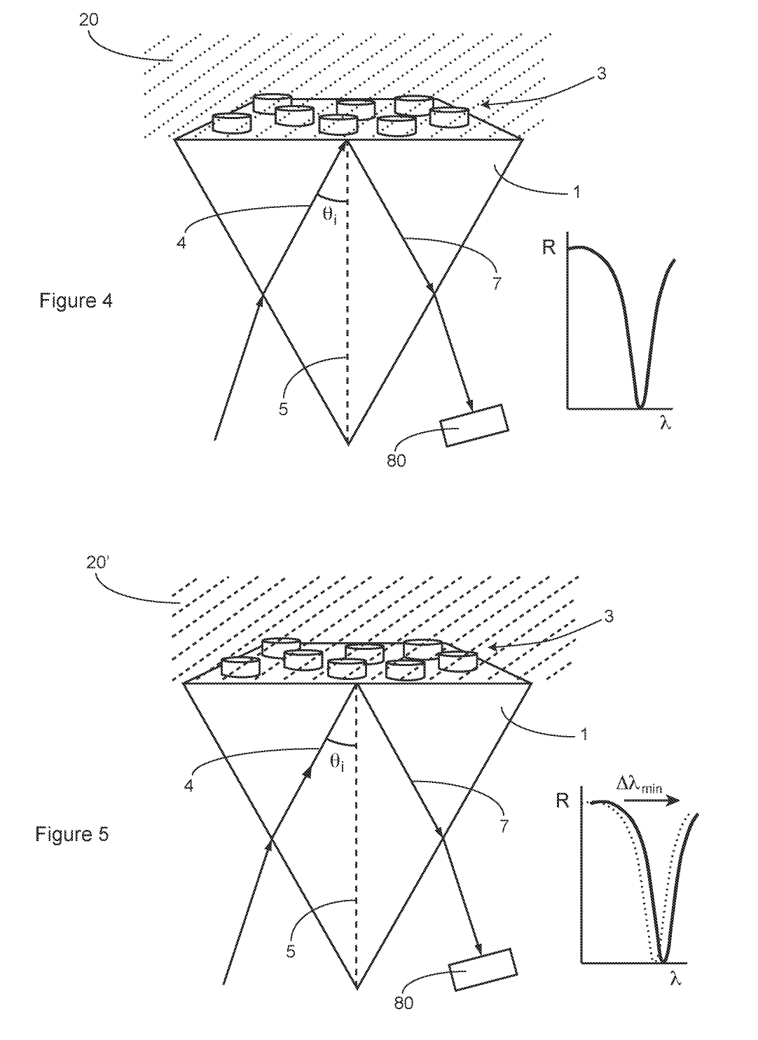

In FIG. 4, bulk refractive index sensing of the second medium (20) is illustrated. Here, the incident light (4) is polychromatic. The reflected light (7) is analyzed by a spectrometer (80) and a reflectance minimum is found at a certain wavelength, as seen in the graph of the reflectance (R) as a function of wavelength (λ) of the reflected light.

FIG. 5 shows an altered second medium (20′) with a refractive index differing from the refractive index of the previous second medium (20). This can be revealed by noting how the reflectance minimum has shifted a distance αλₘᵢₙ.

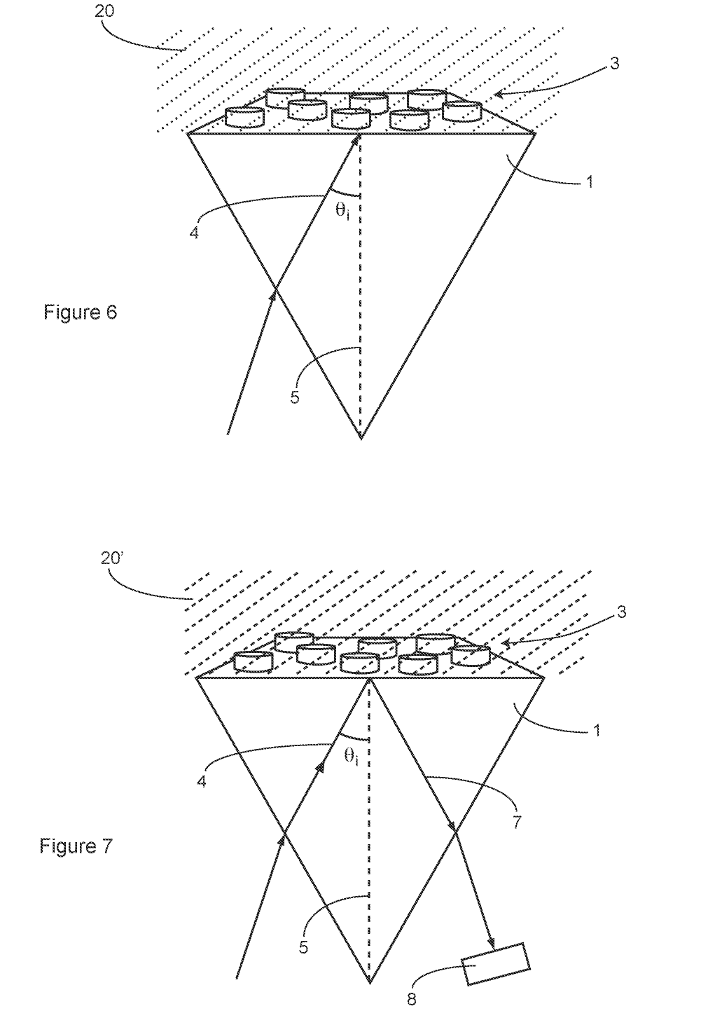

FIG. 6 also illustrates bulk refractive index sensing of the second medium (20), but here the incident light (4) is monochromatic. The angle θᵢ is chosen so that total absorption is achieved for the second medium (20). But when the second medium is altered into (20′) as shown in FIG. 7, the total absorption condition is no longer fulfilled and reflected light (7) will be detected by a detector (8).

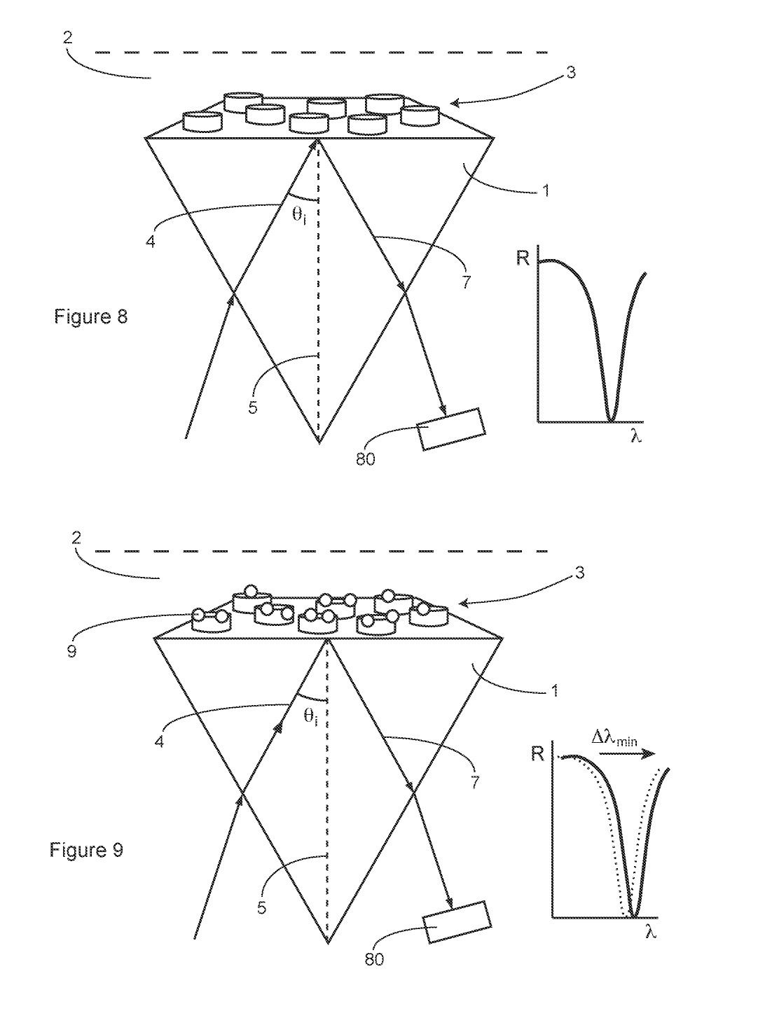

FIG. 8 illustrates a spectroscopic measurement of a bare or functionalized inclusion structure (3). When molecules (9) are adsorbed to the inclusion structure (3), as illustrated in FIG. 9, the local refractive index is changed. The change in local refractive index is sensed by noting how the reflectance minimum has shifted a distance Δλₘᵢₙ.

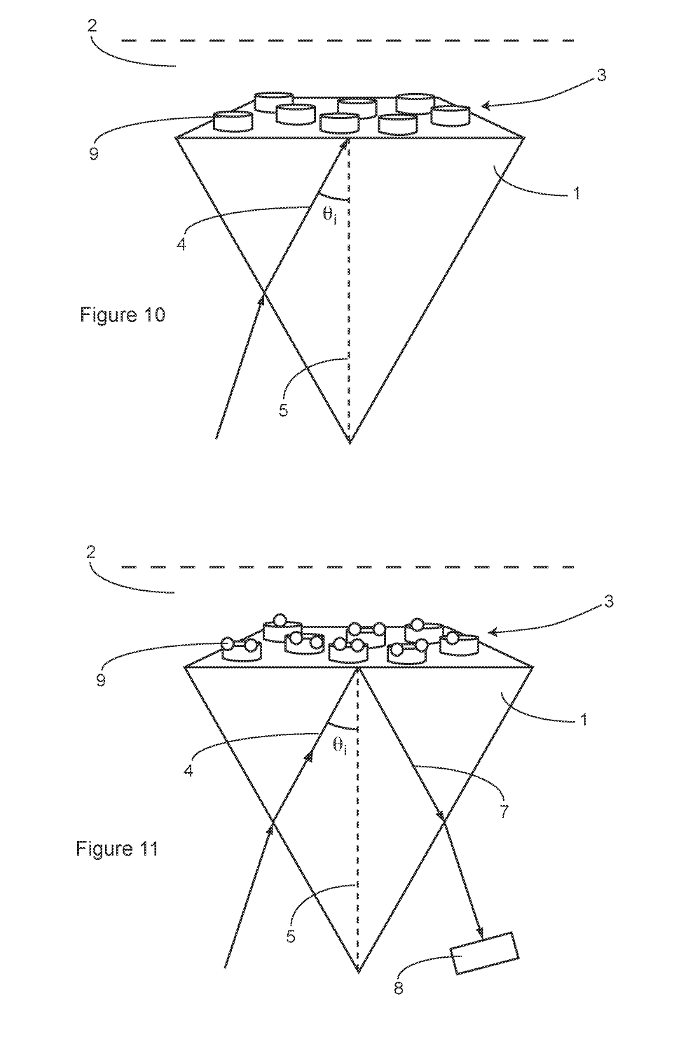

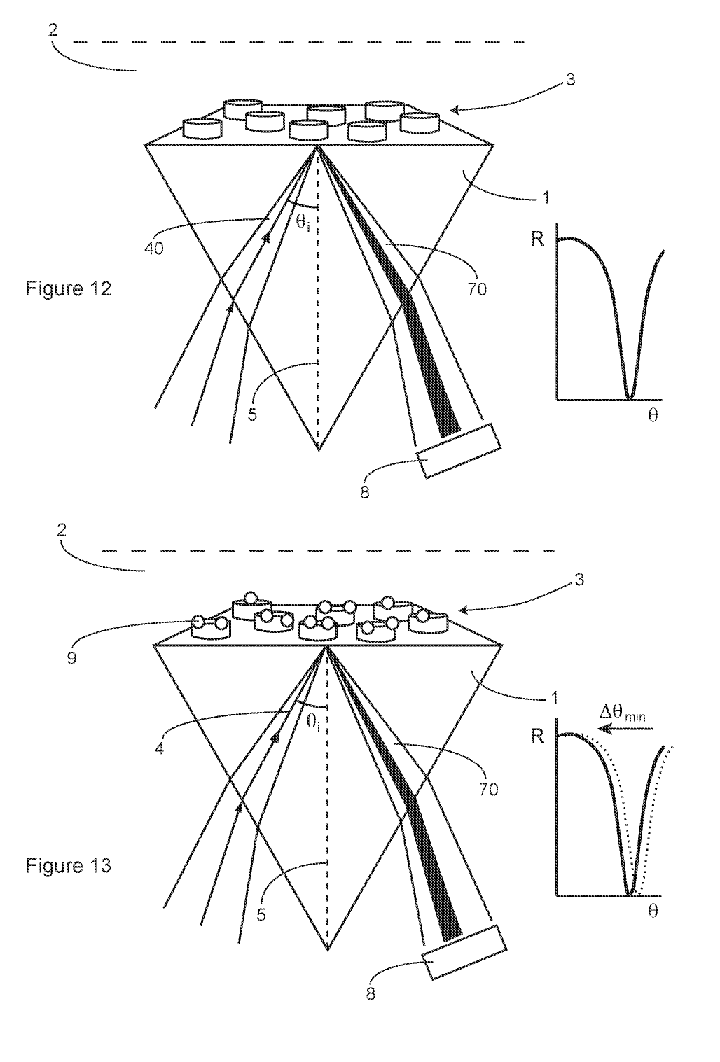

FIGS. 10 and 11 also illustrates local refractive index sensing, but here the incident light (4) is monochromatic. The angle θᵢ is chosen so that total absorption is achieved with a bare or functionalized inclusion structure (3), as shown in FIG. 10. But when molecules (9) are adsorbed to the inclusion structure, as shown in FIG. 11, the total absorption condition is no longer fulfilled and reflected light (7) will be detected by a detector (8).

In FIG. 12, converging incident light (40) is directed through the first medium (1) towards the bare/functionalized inclusion structure (3) at the boundary to the second medium (2). The reflectance R has a minimum at a certain angle θ, as can be seen in the graph. When molecules (9) are adsorbed to the inclusion structure (3), as shown in FIG. 13, the angle for total absorption is shifted by Δθₘᵢₙ.

FIGS. 14 and 15 illustrate phase measurements of the reflected light. A first beam splitter (10) splits the incident light (400) into a signal beam (401) and a reference beam (401). At a second beam splitter (11), the reference beam (401) interferes with the reflected light (7). This can be measured as a function of intensity (I₁, I₂, I′₁, and I′₂), or by the detecting the movement of the interference fringes.

FIGS. 16 and 17 illustrate a common path method for phase measurements. This method utilizes the interference between the p- and s-polarized components of the incoming light (400). The phase difference between the components can be deduced by rotating a polarizer (12) and/or a retardation plate (13) and studying the reflection intensity or spectrum detected by a detector (8).

In essence, equations (3)-(5) describe the impedance matching conditions for achieving total absorption of the incident light. The new insight of the origin of total absorbance can be used for several purposes, including refractometric sensing, surface enhanced spectroscopies and optical trapping techniques.

The sensing device exemplified includes nanooptical antennas organized on a solid support. The nanooptical antennas can be made of one or several metals, graphene or semi-conductors and each nanoantenna supports a localized plasmon resonance (LSPR). The nanoantennas are smaller than the utilized excitation wavelength, typically 300-1500 nm, implying largest nanoantenna dimensions of the order of 100-1000 nm. The reflection from such a device is made from two main components: The reflection of the solid support and the surrounding environment and the coherent scattering of the nanoantennas in the reflection angle. As discussed above, this may lead to strongly asymmetric spectroscopic line shapes and total absorbance of the incident light.

A main point of the present invention is the combination of the angle dependent excitation conditions of spectroscopically asymmetric or total absorbing modes and the spectroscopic, intensity, angular or phase read-out methodologies, in order to detect changes of the nanoantennas and/or the surrounding environment upon at least local changes in chemical composition/temperature/pressure of the surrounding medium.

The optical response of metallic nanoparticles is known to be sensitive to the refractive index of the surrounding medium. General measurement techniques are based on optical measurements of extinction, scattering and/or reflection of visible to near infrared light (wavelengths from around 400-1500 nm). The plasmonic resonance is conveniently described as a Lorentzian function, with a resonance position and amplitude that both are sensitive to the surrounding refractive index. Therefore, it is common to measure the response of such a sensor by either the shift of the spectral maximum, λₘₐₓ, representing the plasmon resonance wavelength, or the intensity or absorbance unit change at a specific wavelength. The description given above relates the reflection line shape and the total absorption condition to both the position and the amplitude of the polarizabilities of the nanoinclusions of the boundary. For instance, the minimum or maximum in the reflection spectra is not only sensitive to the resonance position, but also the amplitude, which gives an enhanced sensitivity. Changes in the optical response of the bare interface can also be utilized for additional sensitivity. Additionally, the zero reflection condition can be utilized as a contrast mechanism in refractometric sensing experiments measuring the intensity or the phase of the reflected light.

Surface enhanced spectroscopies and optical trapping methodologies utilize large enhancements of optical fields surrounding metal nanostructures. Exciting the structures at the specific wavelength and incidence angle for total absorbance maximizes coupling efficiency of the incident light to the near fields of the metal nanostructures. The specified incident angle and wavelength for zero reflection above the critical angle is therefore the most efficient excitation configuration.

Incoherent or inelastic spectroscopy techniques (where the signal is detuned from the excitation wavelength) can be utilized together in total absorption excitation geometry. Tuning the excitation to achieve zero reflection gives the additional advantage of a significantly decreased need for extremely efficient excitation filters. Several surface enhanced spectroscopies, such as Surface Enhanced Raman Spectroscopy (SERS), are relatively inefficient and need very good notch filters not to have the signal overwhelmed by the excitation light. Removing most of the excitation wavelength already at the sample surface effectively decreases the need for such filters.

Examples of possible realizations of the method are illustrated in FIGS. 2-17. FIGS. 2-3 illustrate how the zero reflection condition can be utilized in surface enhanced spectroscopies. Using polarized monochromatic light incident through a prism, the incidence angle, θᵢ, and the wavelength may be tuned to the perfect absorption condition. Therefore, as the nanoantennas absorb all light, the near fields surrounding the nanoantennas are strong, enhancing the surface enhanced process. For instance, if the process is surface enhanced fluorescence (SEF), there is less need to block or filter out the excitation wavelength, while the signal is considerably enhanced due to the large near fields.

FIGS. 4-7 show how bulk refractometric sensing may be done. By utilizing polarized light and the same prism coupling of the excitation light as described above, either spectroscopic (FIGS. 4-5) or intensity (FIGS. 6-7) measurements may be utilized for sensing the sensing media refractive index or the refractive index changes. For spectroscopy either the asymmetric line shapes may be studied or the deep dips above the critical angle. Zero reflectance can be used in intensity measurements to increase the relative intensity contrast. As metallic nanoantennas supporting LSPRs are sensitive to the surrounding refractive index up to 10-100 nm from the metal surface, one can also detect small molecules in the vicinity of the metal nanoparticles using the same methodologies, as illustrated in FIGS. 8-11.

The minimum reflection angle can be utilized to track changes in the sensing medium. For example the adsorption of small molecules to or near to the nanoantennas can be tracked by focusing the incident light on the sample. The reflected light will have angle dependent intensities, with a minimum at the total absorbance angle, for a given excitation wavelength.

Changes of the refractive index of the surrounding media lead to an increased optical phase shift. Examples of how measurements of the phase may be done are illustrated in FIGS. 14-17. By letting the beam interfere with another beam, a reference beam, one may retrieve information on the optical phase of the light from the sample. In a dual path setup (FIGS. 14-15), this may be realized by the utilization of two beam splitters: One in front of the prism coupler and one after. A part of the initial beam will reflect on the sample and exit the prism to the right, while the other part immediately is reflected to the combining beam splitter. The output of the combining beam splitter can be monitored by photodiodes or, if the two beams are not combined to form parallel outgoing paths, in a fringe tracking mode. In the intensity configuration, the intensity will show a sinusoidal pattern with increasing refractive index of the surrounding media. In the fringe tracking mode, the fringes will move accordingly, with maxima and minima moving depending on the phase shift of the reflected light. The optical phase difference between the p- and s-polarized components can also be measured, for instance with the use of an ellipsometer or as illustrated in FIGS. 16-17. Here the individual components strengths and/or phases can be modulated with the rotation of a polarizer or a retarder. Information of the optical phase difference is easily deduced from the reflected intensity, knowing the position of the retarder and the polarizer.

The invention is not limited by the embodiments described above but can be modified in various ways within the scope of the claims. For instance, it is not necessary that the first medium has a prism shape; it can have any shape provided that (a certain wavelength fraction of) the light can propagate through it towards the inclusion structure. Preferably, the first medium also forms a solid support for the inclusion structure.

To find the proper angle of the incident light it is possible to calculate an approximate value of the polarizability a as to obtain an approximate starting value for the angle. From there the angle can be adjusted to find the proper angle, suitably by using a detector for detecting the refraction and confirming the absence of refraction at the proper angle.

As an alternative or complement to metal nanodiscs, the sub-wavelength inclusion structure can comprise quantum dots and/or J-aggregates.

Although the phenomenon is denoted total absorption it is not necessary for the function of the invention that the absorption is 100%. Both the incident angle and the wavelength of the light may differ slightly from the theoretically optimal value. An absorption of more than 95% is suitable for achieving a good effect. In some applications even a lower absorption can be sufficient.

The inventive method results in an enhancement of the near fields of the inclusion structure which can also be used for photocatalysis and/or local heating. The former is of interest in solar harvesting applications and the latter in studies of how e.g. proteins, polymers or other biomolecules change their morphology when heated.

The inventive method is not limited to changes in the second medium but can be used also when the sub-wavelength inclusion structure itself changes. For instance, if the inclusion structure comprises palladium nanoparticles and if hydrogen gas is present, hydrogen will, to an extent depending on the pressure, incorporate into the structure of the palladium particles and affect the polarizability of the sub-wavelength inclusion structure. This will have an influence on the light refraction from the inclusion structure in a similar way as changes in the second medium as described above. Oxidation of the inclusion structure can have a similar effect.

1. Method for exciting a sub-wavelength inclusion structure (3), comprising the step of:
providing a first medium having a first refractive index nᵢ and a second medium having a second refractive index nₜ, wherein nᵢ>nₜ wherein the sub-wavelength inclusion structure is arranged at a boundary between the first and second media, wherein the sub-wavelength inclusion structure exhibits polarizability properties, and
directing light through the first medium towards the sub-wavelength inclusion structure, wherein the angle of the incident light to the normal of the boundary, θᵢ, is such that it, for a given set of:
frequency of the light ω;
surface density of inclusions ρ;
average polarizability a of the inclusion structure at the frequency ω;
first refractive index nᵢ; and
second refractive index nₜ,
fulfills at least one of:
the following relation for s-polarized light:
$$\frac{ω}{c} ρ α ( ω ) = {n}_{t} \vert cos {θ}_{t} \vert + {in}_{i} cos {θ}_{i} ,$$
and;
the following relation for p-polarized light:
$$\frac{ω}{c} ρ α ( ω ) = - \frac{{n}_{t}}{\vert cos {θ}_{t} \vert} + i \frac{{n}_{i}}{cos {θ}_{i}} ,$$
where c is the speed of light in vacuum, where i is the imaginary unit, and where θₜ is the light propagation angle in the second medium determined by the law of refraction:
nₜ sin θₜ=nᵢ sin θᵢ.

2. Method according to claim 1, wherein the method further comprises the step of:
measuring or detecting a response from the sub-wavelength inclusion structure upon an at least local change in chemical composition, temperature and/or pressure of the second medium or upon a change of the sub-wavelength inclusion structure itself.

3. Method according to claim 2, wherein the step of measuring or detecting the response from the sub-wavelength inclusion structure comprises measuring or detecting light emitted from the sub-wavelength inclusion structure or from substances interacting with the sub-wavelength inclusion structure.

4. Method according to claim 1, wherein the sub-wavelength inclusion structure comprises a plurality of individual sub-wavelength inclusions, each of which being capable of supporting a localized surface plasmon resonance.

5. Method according to claim 1, wherein the first medium forms a solid support for the sub-wavelength inclusion structure.

6. Method according to claim 1, wherein the individual sub-wavelength inclusions have a length or diameter of less than 1000 nm.

7. Method according to claim 1, wherein the first medium is a glass material.

8. Method according to claim 1, wherein the second medium is air, water or an aqueous solution.

9. Method for carrying out refractometric sensing, surface enhanced spectroscopy and/or optical trapping, comprising a method according to claim 1.

10. Method according to claim 9, wherein
i) the light is monochromatic, and the incidence angle and/or the frequency of the incident light is chosen such that total absorption is achieved, and a change in the second medium and/or the inclusion structure detected or measured by detection or measurement of reflected light, and by determining the second refractive index nₜ by using at least one of the relations, or
ii) the light is polychromatic, and measuring reflected light with a spectrometer, thereby measuring reflectance as a function of wavelength of the incident light, and determining the second refractive index nₜ from a minimum in the reflectance using at least one of the relations.

11. Method according to claim 9, comprising measuring an optical phase shift in the light induced by the reflection, whereby the measurement of the optical phase shift is performed by
i) splitting the incident light beam into a signal beam which is directed onto the inclusion structure and a reference beam, and measuring interference between the reflected light beam and the reference beam, or by
ii) measuring the interference of s-polarized and p-polarized components of the incident light after reflection by the inclusion structure.

12. Arrangement for carrying out refractometric sensing, surface enhanced spectroscopy and/or optical trapping according to claim 9, the arrangement comprising:
a first medium having a first refractive index nᵢ,
a second medium having a second refractive index nₜ,
a sub-wavelength inclusion structure arranged at a boundary between the first and second medium,
at least one detector, photodiode, spectrometer or ellipsometer arranged to receive a reflected light beam which has been reflected by the inclusion structure.

13. Arrangement according to claim 12, further comprising:
a first beam splitter arranged for splitting incident light into a signal beam and a reference beam,
a second beam splitter arranged where the reference beam will interfere with a reflected light beam,
photodiodes or a fringe tracking arrangement arranged for monitoring interference of the reference beam and the reflected beam.

14. Arrangement according to claim 12, further comprising:
i) and ellipsometer arrangement to measure a phase difference between s-polarized and p-polarized components of the reflected light beam, or
ii) a polarizer and/or a retardation plate arranged to modulate the incident light and detector or spectrometer arranged to measure reflection intensities or spectrum of the reflected beam.

15. Arrangement according to claim 12, wherein
i) the first medium is a solid support for the inclusion structure, the solid support preferably being prism shaped, and where the solid support preferably is a glass material, preferably a borosilicate glass, sapphire, silicon, silica/quartz, indium tin oxide or lithium niobate, and/or
ii) the second medium is air, water, an aqueous solution or an organic solution, and/or
iii) the inclusion structure comprises a plurality of individual sub-wavelength inclusions, preferably Au nanodiscs, quantum dots, and/or J-aggregates, or a combination thereof, the inclusions preferably having a length or diameter of less than 1000 nm, preferably in a size range less than 100-1000 nm.
